(19) United States
(12) Patent Application Publication
(10) Pub. No.: US 2026/0155347 A1
(43) Pub. Date: Jun. 4, 2026

(54) Method and Device for Preparing a Dry Powder Product

(71) Applicant: Matthews International GmbH, Vreden (DE)

(72) Inventors: Thorsten BÖING, Vreden (DE); Christoph Theodor LANSING, Vreden (DE); Tobias WILLEMSEN, Vreden (DE); Phillip RÖRING, Vreden (DE); Ronny SCHLEGEL, Vreden (DE); Thomas HACKFORT, Vreden (DE)

(21) Appl. No.: 19/407,167

(22) Filed: Dec. 3, 2025

(30) Foreign Application Priority Data
Dec. 4, 2024 (DE) 10 2024 135 997.8

(51) Int. Cl. H01M 4/04; B01J 2/10; B01J 19/14

(52) U.S. Cl. CPC H01M 4/048; B01J 2/10; B01J 19/14; H01M 4/0471

(57) ABSTRACT

The application is directed to a method of preparing a dry powder product to be used in energy storage and/or conversion device component production, comprising providing a dry powder product; positioning the dry powder product within a storage room of a trajectory mixer, and homogenizing and/or agitating the dry powder product by moving the storage room of the trajectory mixer, as well as a device for preparing a dry powder product to be used in energy storage and/or conversion device component production, and a lid for a trajectory mixer.

### CROSS-REFERENCE TO RELATED APPLICATIONS

The present application claims priority to German Patent Application No. 10 2024 135 997.8 filed Dec. 4, 2024, which is incorporated herein by reference in its entirety.

### DESCRIPTION

The present claimed subject matter is direct to a method of preparing a dry powder product to be used in energy storage and/or conversion device component production as well as a device for preparing a dry powder product to be used in dry battery electrode component production.

In the industry there is a high interest of replacing batteries using wet coating technologies by batteries using dry battery electrode technology. In such batteries a dry mixture of active materials and conductive additives is applied to respective substrates.

When manufacturing a battery component for battery production, like an anode or cathode film for dry battery production, the raw materials must be crushed and mixed before the film is produced. These two processes are crucial to ensure that the film produced is of optimum quality. Particles that are too large, too small or incompletely mixed will result in poor film formation.

In the prior art it has been proposed to use mixing processes wherein the raw material is mixed in a storage room in which also an agitator that moves relative to the storage room and the raw material positioned within the storage room generally comparable to a kitchen blender used to produce a doughy.

Examples of such mixers are given in CN 117 393 760 A and CN 112 968 164 B, respectively. These mixers have proven themselves in principle for the preparation of materials used in the battery production using wet coating technologies. The raw material is provided in form of a slurry that is mixed. In particular the mixers allow to reach a high homogenization of solid particles suspended within the fluid forming the slurry.

However, such mixers are not usable for the preparation and homogenization of dry powder products that are not suspended in a liquid. A dry powder product mixed in these mixers tend to form agglomerates, which prevents a good mixing result and leads to a poor homogenization. It is assumed that the particles form agglomerates on impact with a wall and agitator. Although these are broken up again by the mixing process, the mixing of the particles is insufficient beside inhomogeneous particles sizes.

Furthermore DE 10 2022 201 990 A1 describes a further device and method for production of mixtures without having a mixing element in a mixing container that can move relative to the container.

It is thus the object of the claimed subject matter to provide a method and a device that allow the preparation of a dry powder product usable in dry battery electrode technology having a high quality, high mixing grade as well as a high homogenization.

The object regarding the method is solved by a method of preparing a dry powder product to be used in energy storage and/or conversion device component production, comprising
providing a dry powder product;
positioning the dry powder product within a storage room of a trajectory mixer, and
homogenizing and/or agitating the dry powder product by moving the storage room of the trajectory mixer.

It is furthermore proposed that the energy storage and/or conversion device comprises at least one dry battery, at least one super capacitor, at least one supercap, at least one hydrofluorocarbon battery, at least one Hydrogen Fuel Cell (HFC) and/or the energy storage and/or conversion device component comprises at least one dry battery electrode component, at least one anode material, at least one cathode material, at least one segregation material, at least one anode component, at least one cathode component, at least one segregation component, at least one film material, at least one pressed material, at least one calendared material, at least one material comprising electrolyte content, optionally absorbed in at least one further material, and/or at least one solid electrolyte.

Furthermore it is proposed that the dry powder product comprises at least one Carbon and/or Graphite material, at least one material comprising electrolyte content, optionally absorbed in at least one further material, at least one solid electrolyte material, Polytetrafluoroethylene (PTFE), Polyvinylidene fluoride (PVDF), conductive Carbon, at least one Carbon nanotube, Graphene, Lithium Nickel Cobalt Aluminium Oxide (NCA) optionally Lithium Nickel Manganese Cobalt Oxide (NMC), Lithium Iron Phosphate (LFP), and/or at least one material comprising Carbon, Fluorine, Phosphorus, Nickel, Iron, Cobalt, Manganese, Aluminum, Sulfur, Lithium, Potassium, Sodium, Zinc, Magnesium, Silica, Silica nanoparticles, Silicon and/or Silicon nanoparticles and/or a combination and/or mixture of different dry materials.

The Method can be Characterized in that
(i) the dry powder product has, in particular before the positioning in the storage room, a humidity portion, optionally defined by the ratio of the mass of water contained in the dry powder product to the total mass of the dry powder product, of less than 0.01%, optionally less than 0,005%, less than 0,002%, less than 0.001%, less than 0,0001%, less than 0.00005% and/or less than 0.00002% and/or has a water content of less than 100 ppm, optionally less than 50 ppm, less than 20 ppm, lees than 10 ppm, less than 1 ppm, less than 0.5 ppm and/or less than 0.2 ppm;
(ii) the dry powder product has, in particular after moving the storage room and/or after removal from the storage room, a humidity portion, optionally defined by the ratio of the mass of water contained in the dry powder product to the total mass of the dry powder product, of less than 0.01%, optionally less than 0,005%, less than 0,002%, less than 0.001%, less than 0.0001%, less than 0,00005% and/or less than 0,00002%, and/or has a water content of less than 100 ppm, optionally less than 50 ppm, less than 20 ppm, lees than 10 ppm, less than 1 ppm, less than 0.5 ppm and/or less than 0.2 ppm.

Also the method might be characterized in that the dry powder product has after moving of the storage room, after removal from the storage room and/or after homogenization a particle size and/or grain size of between 0.01 μm to 750 μm, preferably between 0.05 μm to 500 μm, between 0,075 μm and 250 μm, between 0.09 μm and 100 μm and/or between 0.1 μm to 50 μm and/or a particle weight of between 2.8*10-14 mg to 2.5 mg, preferably between 2.8*10-14 mg to 3.5*10⁻⁹ mg

It is Also Proposed that
(i) positioning the dry powder product within a storage room comprises filling 15% to 85%, preferably 25% to 75%, more preferably 50% to 66% of the storage room, optionally an inner space of the storage room, with the dry powder product;
(ii) the moving of the storage room comprises the movement of the storage room along a 2-dimensional trajectory, optional along at least one, preferably a plurality of lissajous figures, and/or along a three dimensional trajectory;
(iii) the storage room, optionally an inner space of the storage room, is at least partly filled and/or fillable with an inert gas and/or has a lower pressure than the surrounding of the storage room and/or has an increased temperature or a reduced temperature relative to the surrounding of the storage room.

In the method the positioning of the dry powder product and/or the moving of the storage room may comprise positioning at least one separator element within the storage room, wherein the separator element is optionally, at least for the moving of the storage room, fixed relative to and/or securely connected to the storage room and/or extends at least partly into the storage room.

For this embodiment it is proposed that the positioning of the separator element comprises connecting, at least indirectly, the separator element with at least one element of the storage room, optionally at least one wall and/or side wall of the storage room, with at least one lid of the storage room, optionally to close at least one opening of the storage room, connecting a lid comprising the separator element or being connected to the separator element with the storage room.

Also it is proposed that the lid is connected to the storage room and/or at least one opening of the storage room is closed by the lid after the dry powder product has been positioned within the storage room and/or the lid is disconnected from the storage room and/or the lid is removed from the opening after moving the storage room, optionally to remove the dry powder product from the storage room.

For the method it is proposed that the separator element is positioned within the storage room before moving the storage room, optionally before positioning the dry powder product within the storage room or after positioning the dry powder product within the storage room and/or the separator element is removed from the storage room after moving the storage room, optionally before removing the dry powder product from the storage room or after removing the dry powder product from the storage room.

The object regarding the device is solved by device for preparing a dry powder product to be used in energy storage and/or conversion device component production, in particular configured to carry out a method according to one of the preceding claims, wherein the device comprises at least one trajectory mixer having at least one storage room into which the dry powder product is positioned and at least one actuator element for moving the storage room.

For the device it is prosed that the actuator element is configured to move the storage room along a two dimensional trajectory, optionally along at least one, preferably along a plurality of, lissajous figures and/or along an at least partly three dimensional trajectory.

Furthermore, it is proposed that the trajectory mixer comprises at least one separator element extending at least partly into the interior and/or inner space of the storage room, wherein the separator element is in optionally exchangeable and/or removable from the storage room.

For the before described embodiment it is proposed that the separator element extends from at least one wall, optionally inner wall and/or side wall of the storage room, is at least, optionally disconnectably and/or indirectly connected to and/or attached to and/or comprised by the storage room, optionally at least one wall of the storage room, wherein preferably the separator element (13) reaches into the storage room with an immersion ration of r between 15% and 99%, preferably between 25% and 98%, between 40% and 97% or between 75% and 96%, with

$$r = \frac{a}{b} ,$$

a being the length of the separator element into a first direction and b being the depth of the storage room, optionally an inner space of the storage room, in the first direction.

It is also proposed that the storage room comprises at least one opening, optionally for positioning the dry powder product within the storage room and/or for removal of the dry powder product and/or at least one lid, for closing and/or covering the opening.

Furthermore, it is proposed that the separator element is at least indirectly connected to, attached to and/or comprised by the lid.

The device may be characterized in that the separator element has at least partly a cross section at least partly comprising a straight form, a rod form, a V-form, a W-form, an M-form, an arched form, a bend form, a spherical form, an elliptical form, a tree-form, a star form and/or grid form.

It is also proposed that the separator element comprises at least one metal material, at least one steel material, at least one ceramic material, at least one plastic material, at least one rubber material and/or at least one glass material.

Additionally or alternatively it is proposed that the device comprises a plurality of separator elements, wherein at least two separator elements have different forms and/or different sizes and/or are made of and/or comprise different materials.

Furthermore it is proposed that the storage room is free of any element moving within the storage room relative to an inner wall of the storage room other than the dry powder, in particular free of any agitator moving within the storage room.

Finally it is proposed that the device comprises at least one vacuum pump, optionally to reduce a pressure within the storage room, optionally an inner space of the storage room, at least one heating element, optionally to increase a temperature within the storage room, optionally an inner space of the storage room, at least one cooling element, optionally to reduce a temperature within the storage room, optionally an inner space of the storage room, and/or at least one inert gas resource, optionally to supply at least one inert gas to the storage room, optionally an inner space of the storage room.

Furthermore a lid for a trajectory mixer is proposed, in particular for a device as described before and/or configured to be used in a method as described before, having at least one separator element, optionally a separator element of a device as described before.

The claimed subject matter is thus based on the astonishing perception that the use of a trajectory mixer allows the production of high quality, highly homogenized and a high mixing grade having dry powder products usable in the dry battery electrode component production to achieve high quality products like films and the like.

A trajectory mixer in the sense of the claimed subject matter is to be understood as a device having a storage room forming a mixing container wherein the mixing container is moved by an actuator at high speeds along adaptable and changeable trajectories. By the movement of the storage room the dry powder product is thrown back and forth inside the storage room and is due to the impact on the walls homogenized and mixed. In the storage room and/or mixing container no agitator movable relative to the interior of the mixing container is provided. The trajectory is in most cases two-dimensional but can also be 3-dimensional.

A humidity of a substance in the sense of the claimed subject matter is to be understood as a humidity portion, optionally defined as the ratio of the mass of water contained in the substance to the total mass of the substance and/or defined by

$$ψ = \frac{{m}_{w}}{m} = \frac{m - {m}_{dr}}{{m}_{w} + {m}_{dr}}$$

wherein ψ is the humidity portion, m_{w} is the mass of the contained water, m_{dr} is the mass of the waterfree substance and m is the complete mass of the substance.

The further advantage of a trajectory mixer is beside the high homogeneity of the mixed dry powder product that the time for mixing is significantly reduced such that mixing process taking hours in other mixers can be carried out in a few seconds.

By the use of a separator that is moving with the storage room and/or that is fixed within the interior of the storage room the mixing result can even be improved. The additional separator elements that also act as mixing elements further improve the mixing behavior. These elements are firmly connected to the storage room and do not perform any active movement. However, it is assumed that the movement of the storage room leads to a relative movement of the particles such that the particles collide with the separator elements. On impact with the separator elements, the agglomerates are further destroyed in addition to a destruction at inner walls of the storage room, and the particles are better mixed.

The storage room can also be evacuated, that there is a vacuum inside of the storage room. Also it can be filled with inert gas. The vacuum or the inert gas avoid reactions of the dry powder with the environmental atmosphere. Also the storage room can be heated or cooled to provide optimal mixing conditions and/or relative humidity.

The positioning of the separator elements at a lid of the storage room has the further advantage that existing trajectory mixers can easily be upgraded without the need to alter the storage room but by just replacing the existing lid with a lid comprising the separator elements. This also leads to a modular configuration as different storage rooms can be combined with different separation elements without the need to hold on stock different storage rooms having different separator elements.

The separator elements can have a surface roughness of 0.05<Rz<500

Additionally, the position of the separator elements at the lid have the advantage that after the mixing process and removing of the lid separator elements are automatically removed from the interior of the storage room. When removing the mixed dry powder product, in particular pouring out of the mixed dry powder product a contact with the separator element that might lead to a re-agglomeration is avoided.

Depending on the size of the particles that heavily depends on the particle material and can range from less than 0, 1 μm (for example nanotubes or silica and silicone nanoparticles) up to 750 μm (for example carbon or NMC particles) before and during the mixing the particle weight is can vary from 2.8*10-14 mg to 2.5 mg.

Further features and advantages of the claimed subject matter will become apparent from the following description of embodiments of the claimed subject matter with the help of the enclosed figures, wherein

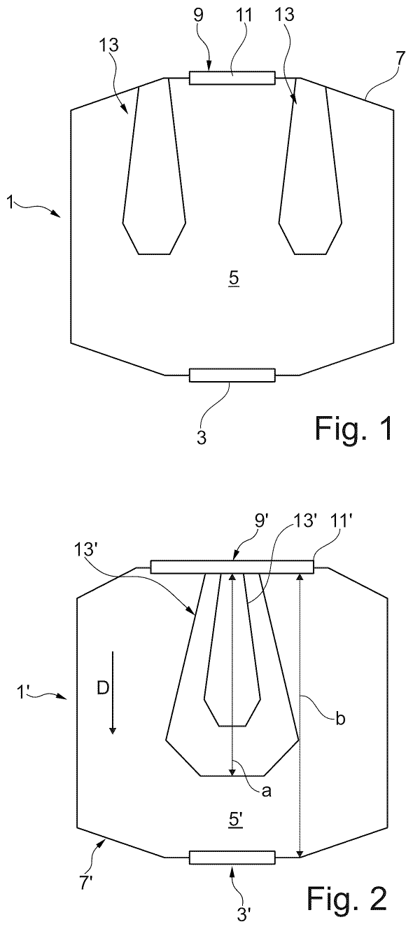

FIG. 1 shows a schematic cross-sectional view of a storage room of a trajectory mixer according to a first embodiment;

FIG. 2 shows a schematic cross-sectional view of a storage room of a trajectory mixer according to a second embodiment;

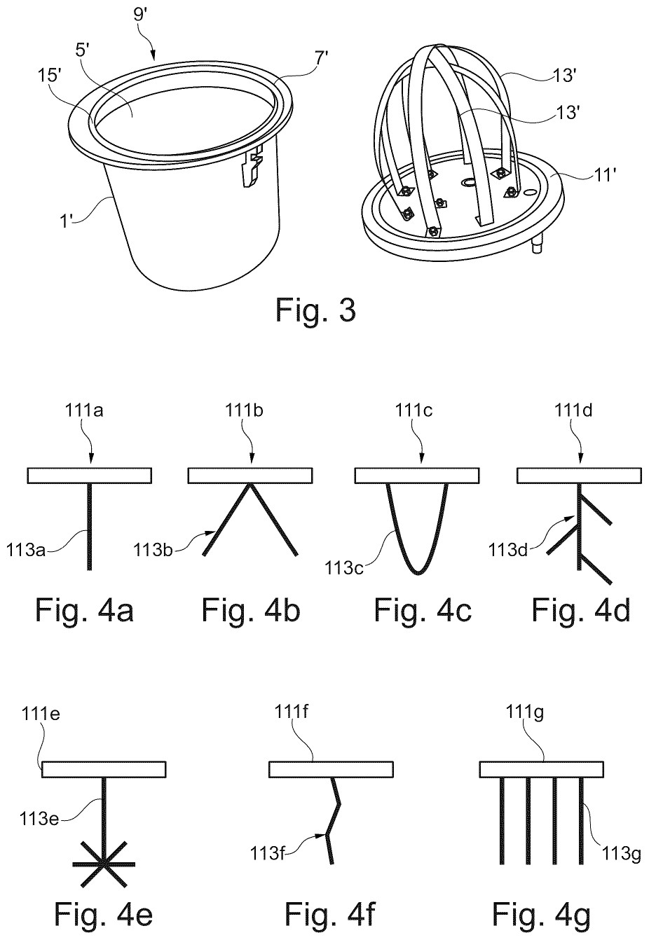

FIG. 3 shows a perspective view onto a practical realization of the storage room of FIG. 2;

FIGS. 4a to 4g show schematic cross-sectional views of lids for a trajectory mixer having respective different separator elements.

FIG. 1 shows a first embodiment of a storage room 1 of a trajectory mixer. The storage room 1 is used as a mixer chamber or mixing container. The storage room 1 can be connected via an interface 3 to a not shown actuator of the trajectory mixer allowing a movement of the storage room along a 2- or 3-dimensional trajectory. For example, the storage room 1 can be placed in a in the figures not shown fixture that is actuated and moved along the trajectory. By the interface 3 the attachment of the storage room within the fixture can be ensured. The storage room 1 has an inner space 5 into which a dry powder product can be positioned to be mixed and/or homogenized by the movement of the storage room 1. The inner space 5 is defined by walls 7.

The storage room 1 has an opening 9 through which the dry powder product can be introduced and positioned within the inner space 5 as well as removed out of the inner space 5, in particular after a mixing process. The opening can be covered and/or closed by a lid 11.

Alternatively or additionally to the function of the interface 3 to attach the storage room 1 to the fixture the interface 3 can be formed as and/or may comprise a further opening that can be closed by a further cover, optionally a lid in the sense of the claimed subject matter. In case the interface 3 comprises an opening the dry powder product can be additionally or alternatively removed out of the inner space through the interface 3.

To increase the homogenization and mixing of the dry powder product separator elements 13 are provided. The separator elements extend into the storage room 1 and/or the inner space 5. In an embodiment said separator elements have an arch form and can be made of or comprise a sheet material. In the embodiment shown in FIG. 1 the separator elements 13 are connected and/or attached to the walls 7. The separator elements 13 thus also act as additional mixing elements that support further the prevention of particles of the dry powder product forming big agglomerates during the mixing process.

The separator elements can be installed in different locations within the storage room 1 and/or the inner space 5. A position on the top as shown in FIG. 1 but also at the bottom, at the side or in corners of the storage room 1 is possible.

In FIG. 2 a second embodiment of a storage room 1′ is shown. The elements of the storage room 1′ that correspond to the elements of the storage room 1 have the same reference numbers, however with one apostrophe. As shown in FIG. 2 the separator elements 13′ are connected to and/or attached to the lid 11′. Furthermore, the separator elements 13′ are realized as elements arrange at least partly one in the other and having different sizes. The location of the separator elements 13′ at the lid 11′ has the before described advantages that existing trajectory mixers and/or storage rooms, in particular of such trajectory mixers can easily be upgraded, in particular allowing a modular configuration and that in particular after the mixing process and removing of the lid 11′ the separator elements 13′ are automatically removed from the interior and/or inner space 5′ of the storage room 1′ such that when removing the mixed dry powder product a contact with the separator elements 13′ that might lead to a re-agglomeration is avoided.

Preferably at least one separator element 13′ extends into the inner space 5′ along a first direction D. Along the first direction the separator element 13′ has a length a. Along the first direction D the depth of the inner space 5′ is b. Preferably the immersion ration r=a/b of at least one of the separator elements 13′ is in the range of 15% to 99%, preferably about 95%.

For a mixing process it is preferred that the storage room 1′ and/or the inner space 5′ is filled up to 50% to 66%. It was found that for such a fill rate the mixing result and homogenization is increased with simultaneously reducing the necessary mixing time. A fill rate of 50% of the dry powder product can be understood as filling the inner space 5′ and/or the storage room to a level that corresponds to 50% of the depth b, i.e. b/2. Additionally or alternatively, it can be understood as filling 50% of the volume of the storage room 1′ and/or inner space 5′ with the dry powered product, optionally at the beginning of the mixing process.

FIG. 3 shows a view onto a practical realization of the storage room 1′ and the lid 11′. As shown in FIG. 3 a sealing element 15′ might be located between the lid 11′ and the wall 7′ of the storage room 1′.

In FIGS. 4a to 4g different lids 111a, 111b, 111c, 111d, 111e, 111f, 111g are shown in schematic cross-sectional view. The lids 111a, 111b, 111c, 111d, 111e, 111f, 111g comprise different separator elements 113a, 113b, 113c, 113d, 113e, 113f, 113g.

As shown the separator elements can be designed in various geometries and arrangements but also may comprise different materials. Depending on the composition and particle size of the dry powder product material, it may be advantageous to adapt the geometry of the separator elements and/or the material of the separator elements, for example steel, plastic and/or rubber, in order to achieve an optimum mixing and/or homogenization result. The separator elements can be rigid, for example steel rod, flexible, for example spring plate and/or rubber, or a combination of both, for example steel rods with rubber elements.

In the shown examples the separator element 113a of lid 111a comprises a straight rod form. The separator element 113b of lid 111b is comprises a V-form, in particular formed by several rods being arranged at an angle. The separator element 113c of lid 111c has a bend or arched form. The separator element 113d of lid 111d has a tree form optionally made of a main rod from which further elements are extending along the length of the main rod, whereas the separator element 113e of lid 111e comprises one main rod with additional colliding elements at the end, that are optionally crossed. The separator element 113f of lid 111f has a elastic and/or flexible element, optionally comprising a thin metal wire and/or stribe. Finally the lid 111g comprises a plurality of separator elements 113g.

The features disclosed in the specification, the claims and the figure may be essential to the invention in its various embodiments, either individually or in any combination.

### REFERENCE SIGN LIST

1, 1′ storage room
3, 3′ interface
5,5′ inner space
7, 7 wall
9, 9′ opening
11, 11′ lid
13, 13′ separator element
15′ sealing element
111a, 111b, 111c, 111d, 111e, 111f, 111g lid
113a, 113b, 113c, 113d, 113e, 113f, 113g separator element
a length
b depth
D direction

1. Method of preparing a dry powder product to be used in energy storage and/or conversion device component production, comprising
providing a dry powder product;
positioning the dry powder product within a storage room of a trajectory mixer, and
homogenizing and/or agitating the dry powder product by moving the storage room of the trajectory mixer.

2. Method of claim 1, wherein the energy storage and/or conversion device comprises at least one dry battery, at least one super capacitor, at least one supercap, at least one hydrofluorocarbon battery, at least one Hydrogen Fuel Cell (HFC) and/or the energy storage and/or conversion device component comprises at least one dry battery electrode component, at least one anode material, at least one cathode material, at least one segregation material, at least one anode component, at least one cathode component, at least one segregation component, at least one film material, at least one pressed material, at least one calendared material, at least one material comprising electrolyte content, optionally absorbed in at least one further material, and/or at least one solid electrolyte.

3. Method of claim 1, wherein the dry powder product comprises at least one Carbon and/or Graphite material, at least one material comprising electrolyte content, optionally absorbed in at least one further material, at least one solid electrolyte material, Polytetrafluoroethylene (PTFE), Polyvinylidene fluoride (PVDF), conductive Carbon, at least one Carbon nanotube, Graphene, Lithium Nickel Cobalt Aluminium Oxide (NCA) optionally Lithium Nickel Manganese Cobalt Oxide (NMC), Lithium Iron Phosphate (LFP), and/or at least one material comprising Carbon, Fluorine, Phosphorus, Nickel, Iron, Cobalt, Manganese, Aluminum, Sulfur, Lithium, Potassium, Sodium, Zinc, Magnesium, Silica, Silica nanoparticles, Silicon and/or Silicon nanoparticles and/or a combination and/or mixture of different dry materials.

4. Method of claim 1, wherein
(i) the dry powder product has, in particular before the positioning in the storage room, a humidity portion, optionally defined by the ratio of the mass of water contained in the dry powder product to the total mass of the dry powder product, of less than 0.01%, optionally less than 0.005%, less than 0.002%, less than 0.001%, less than 0.0001%, less than 0.00005% and/or less than 0.00002% and/or has a water content of less than 100 ppm, optionally less than 50 ppm, less than 20 ppm, lees than 10 ppm, less than 1 ppm, less than 0.5 ppm and/or less than 0.2 ppm;
(ii) the dry powder product has, in particular after moving the storage room and/or after removal from the storage room, a humidity portion, optionally defined by the ratio of the mass of water contained in the dry powder product to the total mass of the dry powder product, of less than 0.01%, optionally less than 0.005%, less than 0.002%, less than 0.001%, less than 0.0001%, less than 0.00005% and/or less than 0.00002%, and/or has a water content of less than 100 ppm, optionally less than 50 ppm, less than 20 ppm, lees than 10 ppm, less than 1 ppm, less than 0.5 ppm and/or less than 0.2 ppm.

5. Method of claim 1, wherein 0.01 μm to 750 μm, preferably between 0.05 μm to 500 μm, between 0.075 μm and 250 μm, between 0.09 μm and 100 μm and/or between 0.1 μm to 50 μm and/or a particle weight of between 2.8*10-14 mg to 2.5 mg, preferably between 2.8*10-14 mg to 3.5*10⁻⁹ mg.

6. Method of claim 1, wherein
(i) positioning the dry powder product within a storage room comprises filling 15% to 85%, preferably 25% to 75%, more preferably 50% to 66% of the storage room, optionally an inner space of the storage room (1, 1′), with the dry powder product;
(ii) the moving of the storage room comprises the movement of the storage room along a 2-dimensional trajectory, optional along at least one, preferably a plurality of lissajous figures, and/or along a three dimensional trajectory;
(iii) the storage room, optionally an inner space of the storage room, is at least partly filled and/or fillable with an inert gas and/or has a lower pressure than the surrounding of the storage room and/or has an increased temperature or a reduced temperature relative to the surrounding of the storage room.

7. Method of claim 1, wherein the positioning of the dry powder product and/or the moving of the storage room comprises positioning at least one separator element within the storage room, wherein the separator element is optionally, at least for the moving of the storage room, fixed relative to and/or securely connected to the storage room and/or extends at least partly into the storage room.

8. Method of claim 7, wherein the positioning of the separator element comprises connecting, at least indirectly, the separator element with at least one element of the storage room, optionally at least one wall and/or side wall of the storage room, with at least one lid of the storage room, optionally to close at least one opening of the storage room, connecting a lid comprising the separator element or being connected to the separator element with the storage room.

9. Method of claim 8, wherein the lid is connected to the storage room and/or at least one opening of the storage room is closed by the lid after the dry powder product has been positioned within the storage room and/or the lid is disconnected from the storage room and/or the lid is removed from the opening after moving the storage room, optionally to remove the dry powder product from the storage room.

10. Method of claim 7, wherein the separator element is positioned within the storage room before moving the storage room, optionally before positioning the dry powder product within the storage room or after positioning the dry powder product within the storage room and/or the separator element is removed from the storage room after moving the storage room, optionally before removing the dry powder product from the storage room or after removing the dry powder product from the storage room.

11. Device for preparing a dry powder product to be used in energy storage device component production, in particular configured to carry out a method according to one of the preceding claims, wherein the device comprises at least one trajectory mixer having at least one storage room into which the dry powder product is positioned and at least one actuator element for moving the storage room.

12. Device of claim 11, wherein the actuator element is configured to move the storage room along a two dimensional trajectory, optionally along at least one, preferably along a plurality of, lissajous figures and/or along an at least partly three dimensional trajectory.

13. Device of claim 11, wherein
the trajectory mixer comprises at least one separator element extending at least partly into the interior and/or inner space of the storage room, wherein the separator element is in optionally exchangeable and/or removable from the storage room.

14. Device of claim 13, wherein the separator element extends from at least one wall, optionally inner wall and/or side wall of the storage room, is at least, optionally disconnectably and/or indirectly connected to and/or attached to and/or comprised by the storage room, optionally at least one wall of the storage room, wherein preferably the separator element reaches into the storage room with an immersion ration of r between 15% and 99%, preferably between 25% and 98%, between 40% and 97% or between 75% and 96%, with
$$r = \frac{a}{b}$$
with a being the length of the separator element into a first direction and b being the depth of the storage room, optionally an inner space of the storage room, in the first direction.

15. Device of claim 13, wherein the storage room comprises at least one opening, optionally for positioning the dry powder product within the storage room and/or for removal of the dry powder product and/or at least one lid, for closing and/or covering the opening.

16. Device of claim 15, wherein the separator element is at least indirectly connected to, attached to and/or comprised by the lid.

17. Device of claim 13, wherein the separator element has at least partly a cross section at least partly comprising a straight form, a rod form, a V-form, a W-form, an M-form, an arched form, a bend form, a spherical form, an elliptical form, a tree-form, a star form and/or grid form.

18. Device of claim 13, wherein
the separator element comprises at least one metal material, at least one steel material, at least one ceramic material, at least one plastic material, at least one rubber material and/or at least one glass material.

19. Device of claim 13, wherein the device comprises a plurality of separator elements, wherein at least two separator elements have different forms and/or different sizes and/or are made of and/or comprise different materials.

20. Device of claim 11, wherein the storage room is free of any element moving within the storage room relative to an inner wall of the storage room other than the dry powder, in particular free of any agitator moving within the storage room.

21. Device of claim 11, wherein the device comprises at least one vacuum pump configured to reduce a pressure within an inner space of the storage room, at least one heating element, configured to increase a temperature within the inner space of the storage room, and at least one cooling element configured to reduce a temperature within the inner space of the storage room, and at least one inert gas resource configured to supply at least one inert gas to the inner space of the storage room.

22. Lid for a trajectory mixer, in particular for a device of claim 11 configured to be used in a method having at least one separator element connected thereto.
